(19) United States
(12) Patent Application Publication
(10) Pub. No.: US 2014/0278862 A1
(43) Pub. Date: Sep. 18, 2014

(54) Social collaborative decision-making platform for shopping

(71) Applicant: Suresh Babu Muppala, Santa Clara, CA (US)

(72) Inventor: Suresh Babu Muppala, Santa Clara, CA (US)

(21) Appl. No.: 13/838,214

(22) Filed: Mar. 15, 2013

(51) Int. Cl. G06Q 30/06

(52) U.S. Cl. CPC G06Q 30/0613
USPC 705/14.16; 705/26.41

(57) ABSTRACT

The proposed embodiment provides a method and system for social collaboration and providing curated content for decision-making. The method includes creating a list for purchasing product(s) by a user and sharing the list with a plurality of users. Further, the method includes receiving product suggestions and curated content associated with the products from the plurality of users/sources, adaptively displaying the curated content to the user for decision-making, and allowing the user to purchase the product(s) based on the decision-made.

The present application is based on, and claims priority from U.S. Provisional Application bearing No. 61/611,449 filed on 15 Mar. 2012, the disclosure of which is hereby incorporated by reference herein.

### TECHNICAL FIELD

The present embodiment relates to decision-support systems, and more particularly to a computer-aided social collaborative decision-making platform for online and in-store purchases.

### BACKGROUND

Generally, most of the customers start product purchase decision-making process by viewing product information from various information sources. The various information sources described herein can include for example, but not limited to, merchant & manufacturer websites, publications, product catalogues, product related blogs, reviews, customer experience, customer support centers, product documentations, social networking portals, and the like. Most of the consumers generally start by using a search engine to gather the information for deciding the product(s) of interest which may create significant challenges for the customers in the decision-making process.

Different systems and methods are available to provide the detailed product descriptions, feature(s) specifications, comparison among various products, and the like information, to fulfill the consumers need and support them for making the decisions. Upon reviewing this information, the consumers may select and/or eliminate the products that they would like and/or dislike to purchase. Further, most of the major retailers and e-shopping websites provide customer reviews to help the consumers in the decision-making process. Typically, the consumers seek opinion from friends, read blogs, analyze product comparison sheets, read reviews, and the like sources, to select the product(s) of interest. Most of such customer reviews available on the merchant websites may not be reliable/trustworthy and may not provide information or address the consumer queries. This may create significant challenges for the customers in decision-making process using such merchant and retailer websites. Furthermore, the conventional systems and methods provide an interleaved decision-making mechanism which allows the customers to visit each source to view the product(s) information. As each source maintains the product information in their preferable formats and due to diverse nature of data available at each source, the conventional systems and methods may be time consuming and expensive. Furthermore, the consumers typically purchase product(s) from trusted merchant. The consumers may primarily be concerned about searching the trusted merchant to purchase at best possible price based on knowledge of historic price trends provided by the various sources.

Though the conventional systems are effective to a degree in providing support to customer in the decision-making process but, includes both advantages and disadvantages in terms of, collaborative decision-making, curated content, customer requirement, trust, reliability, time, cost, security, pricing trends, trusted merchants for buying, product reviews, product information, integration of the information, standards, optimization, and the like.

### BRIEF DESCRIPTION OF THE FIGURES

The embodiments herein will be better understood from the following detailed description with reference to the drawings, in which:

FIG. 1 is a block diagram illustrates generally, among other things, a high level architecture of a system, according to embodiments described herein;

FIG. 2 is a sequence diagram illustrates generally, operations performed by the system as described in the FIG. 1, according to embodiments described herein;

FIG. 3 is a diagram illustrates generally, an exemplary GUI showing a smart list created by a customer, according to embodiments disclosed herein;

FIG. 4 is a diagram illustrates generally, an exemplary GUI showing smart list populated with products and corresponding curated content for the smart list as described in the FIG. 3, according to embodiments disclosed herein;

FIG. 5 is a diagram illustrates generally, another exemplary GUI showing a different view in which users can rate products to help with shopping decisions for the smart list as described in the FIG. 3, according to embodiments disclosed herein;

FIG. 6 is a diagram illustrates generally, an exemplary GUI showing pricing trend for products in the smart list as described in the FIG. 3, according to embodiments disclosed herein;

FIG. 7 is a diagram illustrates generally, an exemplary GUI showing feedback shared by customer for purchased/eliminated products as described in the FIG. 6, according to embodiments disclosed herein;

FIG. 8 is a flow chart illustrates generally, a method for providing social collaboration and curated content to guide a customer for purchase decision-making, according to embodiments disclosed herein; and

FIG. 9 is a diagram illustrates generally, an exemplary computing environment implementing the method and system, according to embodiments disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein disclose a platform for social collaboration and a system and method for adaptively providing curated content for decision-making. A server can be configured to allow a customer to create a list indicating the shopping requirement of the customer. The customer can add or remove one or more products into the list and share with a plurality of users over a communication network. The plurality of users described herein can include for example, but not limited to, the customer friends, family, other customers/users, bloggers, manufacturers, merchants, administrators, social portal users, or any other users. The server can be configured to receive product suggestion and curated content from the plurality of users corresponding to the requirements as indicated in the list by the customer. The curated content described herein can include for example, but not limited to, user reviews, user ratings, recommendations, user experience, product specifications, product features, user likes, user dislikes, pricing trends, product videos, product images, product related questions, product related answers, uniform resources locators, documents, and the like.

Unlike conventional systems, the server can be configured to adaptively provide the curated content received from the plurality of users and sources to the customer, such as to make the decision-making process simple and efficient for the customer. The embodiment provides a social collaborative decision-making platform to the customer for efficiently making online and in-store purchase decisions. Further, the server can be configured to adaptively display the curated content corresponding to the interested products and requirements as indicated in the list by the customer. The customer can view and analyze the curated content received from the plurality of users and sources in order to make decisions such as for example, the product purchase, product elimination, or delaying the products purchase. Furthermore, the server can be configured to allow the customer to purchase/eliminate the product(s) based on the decision made and share feedback for the purchased/eliminated products with the plurality of users.

The proposed embodiment is simple, reliable, dynamic, and robust for providing a social collaborative decision-making platform. Unlike conventional systems, the present embodiment provides the social collaborative decision-making platform by enabling shopping collaboration with other users and integrating the products related curated content received from the plurality of users and sources. Such social collaborative decision-making platform can be used to make the consumer decision-making process simple and efficient. The platform can be used to provide a curated content following a common format for all the products information throughout the system, such as to significantly decrease the customer time for searching the product(s) information and increase the overall customer experience. The needs of the customers can be clearly described by allowing the customers to create the list of the interested products. For example, if a customer needs to purchase a light-emitting diode (LED) Television (TV) with high resolution and Wi-Fi connectivity, then the customer can clearly describe their needs and select the desired products by eliminating other similar products (which provides high resolution but does not include Wi-Fi connectivity, or vise versa). Further, the customers generally purchase the product(s) from trusted merchants so, the system can be used to provide an option to the customers for purchasing the products from verified and trusted merchants. The system can be used to provide historic pricing trends in order to facilitate the customer to purchase the products at best possible price based on knowledge of the pricing trends. Furthermore, the proposed system and method can be readily implemented on the existing infrastructure and may not require extensive set-up or instrumentation.

Throughout the description the terms, customer and user are used interchangeably.

Throughout the description the terms, product and item are used interchangeably.

Referring now to the drawings, and more particularly to FIGS. 1 through 9, where similar reference characters denote corresponding features consistently throughout the figures, there are shown embodiments.

FIG. 1 is a block diagram illustrates generally, among other things, a high level architecture of a system 100, according to embodiments described herein. The system 100 includes a server 102 (central device) and one or more user devices 104 (hereafter referred as user device(s) 104) communicating among each other over a communication network 106.

In an embodiment, the user devices 104 described herein can include for example, but not limited to, personal computer, personal digital assistance (PDA), mobile device, smart phone, desktop computer, laptop, tablet, consumer electronic devices, monitor, television, or any other electronic device controlled and managed by the user(s). The user devices 104 can be configured to directly (via wired connection) or indirectly (via wireless connections) communicate with the server 102 over the communication network 106. In an embodiment, the communication network 106 described herein can include for example, but not limited to, wireless network, wire line network, global system for mobile communication, cellular network, local area network, wide area network, metropolitan area network, combination thereof, or any other network.

In an embodiment, the server 102 described herein can be any general purpose computer capable of managing and controlling data over the communication network 106. The server 102 can be configured to include various interfaces to communicate with various internal and external components of the system 100. The server 102 can be configured to include or coupled to a data store 108. The data store 108 can be configured to store various information received from the user devices 104 over the communication network 106. Unlike conventional systems, the server 102 can be configured to provide a social collaborative decision-making platform to the users for efficiently making online and in-store purchase decisions. Further, the system 100 allows the different users/customers to log into the server 102 through the user device 104 and perform various operations during the decision-making process. The various operations performed by the system 100 are described in conjunction with the FIG. 2.

Though the FIG. 1 shows one server 102 and few numbers of user devices 104 communicating among each other but, it is to be understood that another embodiment is not limited thereto. Further, the system 100 can include any number of servers and customer devices along with other hardware or software components communicating among each other over the communication network. For example, the component can be, but not limited to, a process running in the controller/processor, an object, an executable process, a thread of execution, a program, and/or a computer. By way of illustration, both an application running on a controller and the controller can be the component.

FIG. 2 is a sequence diagram 200 illustrates generally, operations performed by the system 100 as described in the FIG. 1, according to embodiments described herein. In an embodiment, at 202, the server 102 can be configured to allow the customers to register and/or log into the server 102. The system 100 allows the customers to log into the server 102 through the user device 104 and perform various operations during the decision-making process. The server 102 can be configured to store the customer preferences into the data store 108. The customer can log into the server 102 using customer credentials such as for example, user ID, emails, password, and the like.

In an embodiment, at 204, the server 102 can be configured to allow the customer to create a list indicating the requirements of the customer. The needs of the customers can be clearly described by allowing the customers to create the list of interested products. The server 102 can be configured to provide a Graphical User Interface (GUI) on the user device 104 for creating the list of interested products. Further, an exemplary GUI showing a smart list created by a customer is described in conjunction with the FIG. 3.

In an embodiment, at 206, the server 102 can be configured to allow the customer to add or remove interested products in the list from various sources. In an embodiment, the various sources describe herein can include for example, but not limited to, manufacturers websites, merchants websites, official websites, social portals, third-party websites, blogs, reviews, recommendation systems, electronic emails, messages, applications, and files and the like. The server 102 can be configured to provide a GUI on the user device 104 to add the interested products list along with the requirements of the customer. The customer can create the list of interested product(s) and send a request including the list to the server 102 for further processing. Further, an exemplary GUI showing a smart list of interested products added by a customer is described in conjunction with the FIG. 4.

In an embodiment, at 208, the server 102 can be configured to allow the customer to share the list with the plurality of users over the communication network 106. In an embodiment, the plurality of users described herein can include for example, but not limited to, the customer friends, family, other customers/users, bloggers, manufacturers, merchants, administrators, social portal users, or any other users. The server 102 can be configured to allow the customer to share the list with other users for getting support from other users in making decision about purchasing the interested products.

In an embodiment, at 210, the server 102 can be configured to receive the curated content from the plurality of users corresponding to the requirements indicated in the list. In an embodiment, the curated content described herein can include for example, but not limited to, user reviews, user ratings, recommendations, user experience, product specifications, product features, user likes, user dislikes, pricing trends, product video, product images, product related questions, product related answers, uniform resources locators, documents, suggestions, and the like. The product suggestions and curated content received from the plurality of users and sources can be used by the server 102 to provide a social collaborative decision-making platform to the customer for efficiently making online and in-store purchase decisions. The social collaborative decision-making platform can be used to provide the curated content (corresponding to requirements mentioned in the list) provided by the various users and sources in order to significantly decrease the customer time for searching the product(s) information and increase the overall customer experience.

In an embodiment, at 212, the server 102 can be configured to adaptively display the curated content corresponding to the products of interest to the customer. The curated content can be dynamically displayed on the user device 104 to support the customer for efficiently making product(s) purchase decisions. Unlike conventional systems, the server 102 can be configured to adaptively provide the curated content received from the plurality of users to the customer, such as to make the decision-making process streamline, simple and efficient for the customer. The server 102 can adaptively display the curated content corresponding to the interested products and requirements as indicated in the list as user makes progress with shopping process. In an embodiment, the server 102 can be configured to dynamically display the curated content based on the preferences associated with the customer. Further, an exemplary GUI showing the curated content to the customer is described in conjunction with the FIGS. 4 and 5.

In an embodiment, at 214, the customer can analyze the product suggestions from users and curated content displayed on the user device 104. In an example, the customer can view and analyze the curated content received from the plurality of users in order to make decisions the product purchase, product elimination, or delaying the products purchase. In an embodiment, at 216, the server 102 can be configured to allow the customer to purchase the interested product(s) based on the decision made. The customer can analyze the product suggestions from users along with curated content and send a request to the server 102 to purchase the interested products. Generally, the customers want to purchase the product(s) from trusted merchants so, the server 102 can be used to provide an option to the customers for purchasing the products from the trusted merchants. The server 102 can be configured to allow the customer to view the historic pricing trends of the products and purchase the products at best possible price based on knowledge of the pricing trends. An exemplary GUI showing the pricing trend to support the customer in purchasing the interested products are described in conjunction with the FIG. 6. Further, the customers generally purchase the product(s) from trusted merchants so, the server 102 can be used to provide an option to the customers for purchasing the products from verified and trusted merchants. In an embodiment, based on the decision made, the customer can purchase the interested products online from the reliable merchants using the server 102, or directly from the merchant website, or the customer can walk into the nearby stores to purchase the interested products offline.

In an embodiment, at 218, the server 102 can be configured to allow the customer to provide feedback for the purchased/eliminated products. The customer can provide feedback/reason for purchasing or eliminated any of the interested products. In an embodiment, at 220, the server 102 can be configured to automatically share the feedback provided by the customer for the purchased/eliminated products. The customers can purchase/eliminate the interested products based on the analysis of the product suggestions from users and curated content, and share feedback or experience with other customers using the server 102. An exemplary GUI showing the feedback shared by the customers for the purchased products are described in conjunction with the FIG. 7.

In an embodiment, at 222, the server 102 can be configured to frequently monitor the products requirement and curated content provided by the users. Any changes in the products requirement and curated content can affect the overall system performance and the customer experience in the decision-making process. The server 102 can be configured to frequently monitor and adaptively update the curated content and notify the user, which in turn helps the customers for effectively making the decisions.

Furthermore, the system 100 can reward the users with credits for their efforts and to promote the curated content among the users, which helps the users during the decision-making process. The system 100 can provide credits to the users for purchasing products, sharing lists, sharing feedback, and the like. The users can be granted with badges to display with their name and on their profile to build reputation among other users using the server 102.

The various operations described herein can be implemented as a computer program product or application where each customer can subscribe and create an individual account to carry out the entire decision-making process. The various operations described with respect to the FIG. 2 can be performed in the order presented, simultaneously, parallel, randomly, or a combination thereof. The operations described herein are only for illustrative purpose and do not limit the scope of the embodiment. Further, in some embodiments, some of the operations can be added, skipped, omitted, or modified without departing from the scope of the embodiment.

Generally, when consumers want to purchase products, they follow a set of predefined stages. The most important aspect while purchasing the products is the decision-making process. Irrespective of whether the final product purchase is conducted online or offline, the consumers loosely follow similar type of stages to perform actions such as product research, product selection, purchase, and share experience during the shopping process. Unlike conventional systems, the present embodiment can be configured to adaptively provide curated content received from the plurality of users to the customer for making the shopping process simple and efficient. The embodiment provides a social collaborative decision-making platform to the customer for efficiently making online and in-store purchase decisions. Exemplary stages corresponding to the operations described in the FIG. 2 during the decision-making process are described in conjunction with the FIGS. 3-7.

FIG. 3 is a diagram illustrates generally, an exemplary GUI 300 showing a smart list 302 created by a customer, according to embodiments disclosed herein. In an embodiment, if any customer desires to purchase product(s) then the server 102 allows the customer to create a smart list as shown in the FIG. 3. The server 102 can provide the GUI 300 on the customer device 104 to create the smart list 302 and support the customer during the decision-making process. The needs of the customers can be described by allowing the customers to create a list of interested products. The smart list 302 described herein can be created for a diverse set of purchasing requirements. For example, the customer can create the smart list for purchasing a High Definition Television (HDTV), for life's events (e.g., birthday celebrations, products for newborn, toys for new born, gifts for baby girl's, and the like), for hobbies (e.g., Digital Single Lens Reflex (DSLR), cooking equipments, and the like), for home and kitchen appliance upgrades, and the like. In an example, as shown in the FIG. 3, the customer creates the smart list for buying a media player. Each smart list can be configured to include a brief description indicating the requirements of the customer such as shown at 304, and any other relevant information, such as shown at 306, which provides additional information to other customers or friends to help the customer with right product decisions.

FIG. 4 is a diagram illustrates generally, an exemplary GUI 400 showing products in the smart list and corresponding curated content for the smart list 302 as described in the FIG. 3, according to embodiments disclosed herein. In an embodiment, the smart list can be in “Cliq & Decide” stage 402 after creation. The server 102 can be configured to provide the GUI 400 on the customer device 104 in order to allow the customer to add the interested products, such as shown at 404. In an embodiment, the customer can add the interested products from the various sources. The various sources describe herein can include for example, but not limited to, server 102, manufacturers websites, merchants websites, official websites, social portals, third-party websites, blogs, reviews, recommendation systems, electronic emails, messages, applications, and files, web crawlers, search engines and the like. For example, the customer can search the product database of the server 102 or can directly enter the product page Uniform Resource Locator (URL) available at the various information sources. In another example, the customer can populate the smart list by scanning product codes using their mobile device while in a store or a catalogue. In an embodiment, in response to adding the products into the smart list, the server 102 can be configured to adaptively provide the curated content corresponding to the interested products of the customer. For example, as shown at 406, the curated content can be dynamically displayed to the customer for the products of interest. The users can receive notifications for the added products to provide the curated content. The server 102 can be configured to dynamically display the curated content based on any of the customers, the customer friends, and/or extended network of the friends, recommendations, likes, dislikes, ratings, written reviews, shared experience, and the like, for the interested products. Further, the server 102 can be configured to dynamically update the curated content based on the preferences associated with the customer.

FIG. 5 is a diagram illustrates generally, another exemplary GUI 500 showing the curated content for the smart list 302 as described in the FIG. 3, according to embodiments disclosed herein. The FIG. 5 shows another view of the smart list content where all the products are listed one after the other and their associated recommendations, dislike, followers, owner and the like details provided by the plurality of users are displayed, such as shown at 502.

In an example, the customer can analyze the product suggestions and curated content related to the interested products of the customer, such as to make an effective decision for purchasing, eliminating, or delaying the purchase of the interested products. Further, in an embodiment, the server 102 allows the creator/owner of the smart list 302 to share the smart list, such as to get help from other users during the decision-making process. For example, as shown at the 504, the server 102 allows the customer to share the smart list 302 with a selected set of customers or any other users. The “shared users”, as shown at 506, of the smart list can be the creator's friends, part of his extended network of friends, or any other user.

Furthermore, the users can get notification about shared smart list through email, social networking websites, instant messenger, short message service, web URL, or the like sources, such as to expedite their feedback and reduce time needed for decision-making. The customers can also access the curated content shared by other users for effectively making the product purchasing decisions. In an embodiment, the customers can ask questions, answer questions, post URLs, embed and/or upload documents, videos, pictures related to the products in the smart list. Any information contributed for a product in one smart list can be automatically displayed in other smart lists that contain the same product(s). Furthermore, based on the analysis of the product suggestions and curated content the customer can eliminate the product(s) from the smart list. In an embodiment, the customer can provide a reason for eliminating the product so that the information when shared with other customers can help them for making better buying decisions. For example, as shown at 508, the customer eliminated two products from the smart list. After elimination, the product goes into elimination list. Further, at any point of time, the server 102 can be configured to provide an option to the customer for adding the products back to the list 302. Furthermore, the users can ask questions, answer questions, post URLs, embed and/or upload documents, videos, pictures related to the products in the smart list 302 even if the products are eliminated.

FIG. 6 is a diagram illustrates generally, an exemplary GUI 600 showing pricing trend for products in the smart list 302 as described in the FIG. 3, according to embodiments disclosed herein. In an embodiment, after, the customer completes the analysis in the “Cliq & Decide” stage 402, the customer enters into the buy stage 602. In an embodiment, based on customers actions on products in the list and the server 102 can dynamically switch to the buy stage 602. For example, the customer can set a rule indicating if the number of items in the smart list equals to “5” from the initial “15” then automatically switch to the buy stage 602. In an embodiment, the server 102 can be configured to allow the customer to purchase the interested products based on the decision made. The server 102 can be configured to display the historic pricing trends for the interested products, such as to support the customer in deciding the best possible price for the products. For example, as shown at 604, the price trends can be displayed as a chart along with useful information such as number of merchants offering the product over time, and the like. Further, the server 102 can also provide the information related to any recent purchases of the products by the customers friends and/or in the extended network. Based on the analysis of the price trends, the customer can make decision about immediately purchasing or delaying the purchase of the interested products. In an embodiment, if the customer purchases the interested products based on the decision made then the server 102 can be configured to automatically record and provide the respective updates to other customers based on the customer preferences.

Furthermore, at any time during this stage, if the customer finds any potential products to purchase then the customer can add them into the list 302. The customer can also go back to the “Cliq & Decide” stage 402 to analyze the curated content shared by the plurality of users. In an embodiment, actions such as adding a new products or getting any new information pertaining to the products in the smart list can also be used as an automatic trigger for switching the smart list 302 from one stage to another.

FIG. 7 is a diagram illustrates generally, an exemplary GUI 700 showing feedback shared by the customer for the purchased/eliminated products as described in the FIG. 6, according to embodiments disclosed herein. In an embodiment, after the customer purchases the products, the customer can share the feedback in the share stage 702. In an embodiment, the server 102 can be configured to allow the customers to share the experience or feedback with other customers for the purchased/eliminated products. The customers can purchase the interested products based on the analysis of the product suggestions and curated content, and share the feedback or experience with other customers. For example, as shown at 704, the customer can provide and share the feedback with other customers or friends. The final feedback shared by the customer can include all the reasons for considering, eliminating, purchasing, and/or delaying the purchase of the products, such as shown at 706, which can be automatically displayed to other customers based on the customer preferences.

FIG. 8 is a flow chart illustrating generally, a method 800 for social collaboration and providing curated content to guide a customer for purchasing decision-making, according to embodiments disclosed herein. The various block of the flow chart is summarized into the individual steps, where some of the steps can be performed by the server 102, customer device 104, the customer, and the like. The method 800 and other description provide a basis for a control program, which can be easily implemented by a microcontroller, microprocessor, or a combination thereof.

In an embodiment, at step 802, the method 800 includes creating a list indicating requirements of the customer. The needs of the customers can be clearly described by allowing the customers to create the list of interested products. In an example, the method 800 allows the server 102 to provide a Graphical User Interface (GUI) to the customer for creating the list of interested products. The customers can provide the interested products list along with their requirements to the server 102 using the GUI.

In an embodiment, at step 804, the method 800 includes adding or removing interested products in the list from various sources. In an embodiment, the various sources describe herein can include for example, but not limited to, from server 102, manufacturers websites, merchants websites, official websites, social portals, third-party websites, blogs, reviews, recommendation systems, electronic emails, messages, applications, web crawlers, search engines and files and the like. In an example, the method 800 allows the server 102 to provide a GUI on the user device 104 to add the interested products list along with the requirements of the customer. The method 800 allows the customers to create the list of interested product(s) and send a request including the list to the server 102 for further processing.

In an embodiment, at step 806, the method 800 includes sharing the list with a plurality of users over the communication network 106. The plurality of users described herein can include for example, but not limited to, the customer friends, family, other customers/users, bloggers, manufacturers, merchants, administrators, social portal users, or any other users. In an example, the method 800 allows the customer to share the list with other users for getting product suggestions and curated content from other users and sources in making decision about purchasing the interested products.

In an embodiment, at step 808, the method 800 includes receiving the curated content from the plurality of users and sources corresponding to the products in the list. In an embodiment, the curated content described herein can include for example, but not limited to, user reviews, user ratings, recommendations, user experience, product specifications, product features, user likes, user dislikes, pricing trends, product video, product images, product related questions, product related answers, uniform resources locators, documents, suggestions, and the like. In an example, the method 800 allows the server 102 to use the product suggestions and curated content received from the plurality of users to provide a social collaborative decision-making platform to the customer, such as to efficiently make online and in-store purchase decisions. The social collaborative decision-making platform can be used to provide the curated content (corresponding to requirements mentioned in the list) provided by the various users and/or from various sources in order to significantly decrease the customer time for searching the product(s) information and increase the overall shopping experience.

In an embodiment, at step 810, during the customer progress though the shopping process, the method 800 includes adaptively displaying the curated content corresponding to the list. In an example, the method 800 allows the server 102 to dynamically provide the curated content on the user device 104, such as to support the customer for efficiently making product(s) purchase decisions. Unlike conventional systems, the method 800 allows the server 102 to adaptively provide the curated content received from the plurality of users and sources to the customer, such as to make the decision-making process simple and efficient for the customer. The server 102 dynamically displays the curated content corresponding to the interested products and requirements indicated in the list. In an embodiment, during the customer progress though the shopping process, the method 800 allows the server 102 to adaptively display the curated content based on the preferences associated with the customer. The method 800 allows the customer to analyze the curated content to make decision about purchasing, eliminating, or delaying the products purchase.

In an embodiment, at step 812, the method 800 includes eliminating the product(s) from the list based on the decision made. In an example, the method 800 allows the customer to analyze the product suggestions and curated content, and eliminate/remove the products which does not meet the customer requirements. In an embodiment, at step 814, the method 800 includes purchasing the product(s) from the list based on the decision made. In an example, the method 800 allows the customer to purchase the interested product(s) based on the decision made. The customer can analyze the product suggestion and curated content provided by the plurality of users/sources and send a request to the server 102 to purchase the interested products. Generally, the customers want to purchase the product(s) from trusted merchants so, the method 800 allows the server 102 to provide an option to the customers for purchasing the products from the verified/trusted merchants. The method 800 allows the customer to view the historic pricing trends of the products and purchase the products at best possible price based on knowledge of the pricing trends. Further, in an embodiment, based on the decision made, the method 800 allows the customer to purchase the interested products online from the reliable merchants using the server 102, or directly from the merchant website, or the customer can walk into the nearby stores to purchase the interested products offline.

In an embodiment, at step 816, the method 800 includes allowing the customer to publishing the list along with feedback for the purchased/eliminated products. In an example, the method 800 allows the customers to purchase/eliminate the products based on the analysis of the list contents (product suggestions and curated content provided by the plurality of users/sources) and share feedback or experience with other customers using the server 102. The final feedback shared by the customer can include all the reasons for considering, eliminating, purchasing, and/or delaying the purchase of the product(s). Further, the method 800 includes dynamically updating and/or displaying the shared feedback to other customers based on the customer preferences.

Further, the method 800 includes monitoring the products requirement and curated content provided by the users. Any changes in the product requirements, products in the list, and curated content can affect the overall system performance and the customer experience in the decision-making process. The method 800 allows the server 102 to frequently monitor and adaptively update the curated content and notify the users associated with the list, which in turn helps the customers for effectively making the decisions. Furthermore, the method 800 includes rewarding the customers with credits for their efforts to promote collaboration and to contribute the curated content among the users, which helps the customers during the decision-making process. The method 800 allows the server 102 to provide credits to the users for purchasing products, sharing lists, sharing feedback, and the like.

The various actions, units, steps, blocks, or acts described in the method 800 can be performed in the order presented, in a different order, simultaneously, or a combination thereof. Further, in some embodiments, some of the actions, units, steps, blocks, or acts listed in the FIG. 8 may be omitted, added, skipped, or modified without departing from the scope of the embodiment.

Thought the above description is described with respect to commerce of products and services but, it is to be understood that the present embodiment can be used in any other business transactions, goods, objects, services, and the like. Further, the present embodiment does not limit the user/server for performing the operations, steps, acts, units, and blocks, described herein completely online, offline, or a combination thereof.

FIG. 9 is a diagram 900 illustrating an exemplary computing environment 902 implementing the method and system, according to embodiments disclosed herein. As depicted the computing environment 902 comprises at least one processing unit 904 that is equipped with a control unit 906 and an Arithmetic Logic Unit (ALU) 908, a memory 910, a storage unit 912, plurality of networking devices 914 and a plurality Input/Output (I/O) devices 916. The processing unit 904 is responsible for processing the instructions of the algorithm. The processing unit 904 receives commands from the control unit 906 in order to perform its processing. Further, any logical and arithmetic operations involved in the execution of the instructions are computed with the help of the ALU 908.

The overall computing environment 902 can be composed of multiple homogeneous and/or heterogeneous cores, multiple CPUs of different kinds, special media and other accelerators. The processing unit 904 is responsible for processing the instructions of the algorithm. Further, the plurality of processing units 904 may be located on a single chip or over multiple chips.

The algorithm comprising of instructions and codes required for the implementation are stored in either the memory unit 910 or the storage 912 or both. At the time of execution, the instructions may be fetched from the corresponding memory 910 and/or storage 912, and executed by the processing unit 904.

In case of any hardware implementations various networking devices 914 or external I/O devices 916 may be connected to the computing environment to support the implementation through the networking unit and the I/O device unit.

The embodiments disclosed herein can be implemented through at least one software program running on at least one hardware device and performing network management functions to control the elements. The elements shown in FIGS. 1 through 9 include blocks, steps, operations, and acts, which can be at least one of a hardware device, or a combination of hardware device and software module.

The embodiment disclosed herein specifies a system and method for proving a social collaborative decision-making platform to guide a customer for purchasing the interested products. The mechanism enables providing product suggestions and curated content from various users/sources in order to guide the customers during the decision-making process. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the embodiment may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for providing social collaboration and curated content for decision-making, the method comprising:
creating a request for purchasing at least one item by at least one user;
sharing said request with a plurality of users;
receiving curated content associated with said at least one item from plurality of users;
adaptively displaying said curated content to said at least one user for decision-making; and
allowing said at least one user to purchase said at least one item based on said decision.

2. The method of claim 1, wherein said method further comprises allowing said at least one user to eliminate said at least one item based on said decision.

3. The method of claim 1, wherein said curated content associated with said at least one item comprises at least one of user reviews, user ratings, recommendations, user experience, item specifications, item features, user likes, user dislikes, item pricing trends, item videos, item images, item related questions, item related answers, uniform resources locators, documents, and suggestions.

4. The method of claim 1, wherein said plurality of users comprises at least one of friends, family, customers, bloggers, manufacturers, merchants, administrators, and social portal users.

5. The method of claim 1, wherein said method further comprises allowing said at least one user to create a list of said at least one item.

6. The method of claim 1, wherein said method further comprises allowing said at least one user to add said at least one item in said list from at least one source.

7. The method of claim 6, wherein said at least one source comprises at least one of hosting server, owner server, manufacturers websites, merchants websites, official websites, social portals, third-party websites, blogs, reviews, recommendation systems, electronic emails, messages, applications, web crawlers, search engines and files.

8. The method of claim 1, wherein said method further comprises allowing said at least one user to add said at least one eliminated item to said list.

9. The method of claim 1, wherein said method further comprises receiving a request from said at least one user for purchasing said at least one item.

10. The method of claim 9, wherein said request comprises said list.

11. The method of claim 1, wherein said request is created for at least one of selecting, trading, renting, and analyzing said at least one item.

12. The method of claim 1, wherein said method further comprises collaborating plurality of users.

13. The method of claim 1, wherein said method further comprises receiving said curated content associated with said at least one item from said at least one source.

14. The method of claim 1, wherein said method further comprises receiving said suggestions associated with said at least one item from said plurality of users.

15. The method of claim 1, wherein said method further comprises storing said curated content received from said plurality of users and said at least one source.

16. The method of claim 1, wherein said method further comprises storing a plurality of preferences associated with said at least one user.

17. The method of claim 1, wherein said method further comprises dynamically updating said curated content based on said plurality of preferences of said at least one user.

18. The method of claim 1, wherein said method further comprises providing at least one decision-making stage for making said decision to said at least one user.

19. The method of claim 1, wherein said method further comprises adaptively updating said curated content based on progress made during said decision.

20. The method of claim 1, wherein said method further comprises allowing said at least one user to provide feedback for said at least one purchased items.

21. The method of claim 1, wherein said method further comprises allowing said at least one user to provide feedback for said at least one eliminated items.

22. The system of claim 1, wherein said method further comprising receiving feedback for decision-making from said plurality of users.

23. The method of claim 1, wherein said method further comprises sharing said feedback with said plurality of users.

24. The method of claim 1, wherein said method further comprises allowing said plurality of users to browse said shared list.

25. The method of claim 1, wherein said method further comprises providing said shared list to said plurality of users for said decision-making.

26. The method of claim 1, wherein said method further comprises allowing said at least one user to promote said curated content associated with said at least one item.

27. The method of claim 26, wherein said method further comprises rewarding said at least one user for promoting said curated content.

28. The method of claim 1, wherein said method further comprises rewarding said at least one user for providing said suggestions.

29. The method of claim 1, wherein said method further comprises monitoring said at least one item of said list.

30. The method of claim 29, wherein said method further comprises notifying said at least one user based on said monitoring result.

31. A system for providing social collaboration and curated content for decision-making, the system comprising a server configured to:
create a request for purchasing at least one item by at least one user,
share said request with a plurality of users,
receive curated content associated with said at least one item from said plurality of users,
adaptively display said curated content to said at least one user for decision-making, and
allowing said at least one user to purchase said at least one item based on said decision.

32. The system of claim 31, wherein said server is further configured to allow said at least one user to eliminate said at least one item based on said decision.

33. The system of claim 31, wherein said curated content associated with said at least one item comprises at least one of user reviews, user ratings, recommendations, user experience, item specifications, item features, user likes, user dislikes, item pricing trends, item videos, item images, item related questions, item related answers, uniform resources locators, documents, and suggestions.

34. The system of claim 31, wherein said plurality of users comprises at least one of friends, family, customers, bloggers, manufacturers, merchants, administrators, and social portal users.

35. The system of claim 31, wherein said server is further configured to allow said at least one user to create a list of said at least one item.

36. The system of claim 31, wherein said server is further configured to allow said at least one user to add said at least one item in said list from at least one source.

37. The system of claim 36, wherein said at least one source comprises at least one of hosting server, owner server, manufacturers websites, merchants websites, official websites, social portals, third-party websites, blogs, reviews, recommendation systems, electronic emails, messages, applications, web crawlers, search engines and files.

38. The system of claim 31, wherein said server is further configured to allow said at least one user to add said at least one eliminated item to said list.

39. The system of claim 31, wherein said server is further configured to receive a request from said at least one user for purchasing said at least one item.

40. The system of claim 39, wherein said request comprises said list.

41. The system of claim 31, wherein said request is created for at least one of selecting, trading, renting, and analyzing said at least one item.

42. The method of claim 31, wherein said method further comprises collaborating plurality of users.

43. The system of claim 31, wherein said server is further configured to receive said curated content associated with said at least one item from said at least one source.

44. The system of claim 31, wherein said server is further configured to receive said suggestions associated with said at least one item from said plurality of users.

45. The system of claim 31, wherein said server is further configured to store said curated content received from said plurality of users and said at least one source.

46. The system of claim 31, wherein said server is further configured to store a plurality of preferences associated with said at least one user.

47. The system of claim 31, wherein said server is further configured to dynamically update said curated content based on said plurality of preferences of said at least one user.

48. The system of claim 31, wherein said server is further configured to provide at least one decision-making stage for making said decision to said at least one user.

49. The system of claim 31, wherein said server is further configured to adaptively update said curated content based on progress made during said decision.

50. The system of claim 31, wherein said server is further configured to allow said at least one user to provide feedback for said at least one purchased items.

51. The system of claim 31, wherein said server is further configured to allow said at least one user to provide feedback for said at least one eliminated items.

52. The system of claim 31, wherein said server is further configured to receive feedback for decision-making from said plurality of users.

53. The system of claim 31, wherein said server is further configured to share said feedback with said plurality of users.

54. The system of claim 31, wherein said server is further configured to allow said plurality of users to browse said shared list.

55. The system of claim 31, wherein said server is further configured to provide said shared list to said plurality of users for said decision-making.

56. The system of claim 31, wherein said server is further configured to allow said at least one user to promote said curated content associated with said at least one item.

57. The system of claim 56, wherein said server is further configured to reward said at least one user for promoting said curated content.

58. The system of claim 31, wherein said server is further configured to reward said at least one user for providing said suggestions.

59. The system of claim 31, wherein said server is further configured to monitor said at least one item of said list.

60. The system of claim 59, wherein said server is further configured to notify said at least one user based on said monitoring result.

61. A computer program product for providing social collaboration and curated content for decision-making, the product comprising:
an integrated circuit comprising at least one processor;
at least one memory having a computer program code within said circuit, wherein said at least one memory and said computer program code with said at least one processor cause said product to:
create a request for purchasing at least one item by at least one user,
share said request with a plurality of users,
receive curated content associated with said at least one item from said plurality of users,
adaptively display said curated content to said at least one user for decision-making, and
allowing said at least one user to purchase said at least one item based on said decision.
